(19) United States
(12) Patent Application Publication
(10) Pub. No.: US 2011/0099863 A1
(43) Pub. Date: May 5, 2011

(54) Display Device With Transitioning Information

(75) Inventor: David Burtch, Unionville (CA)

(73) Assignee: DIMENSIONAL PRODUCTS LTD., Unionville (CA)

(21) Appl. No.: 12/903,446

(22) Filed: Oct. 13, 2010

Related U.S. Application Data
(60) Provisional application No. 61/255,933, filed on Oct. 29, 2009.

(30) Foreign Application Priority Data
Aug. 31, 2010 (CA) 2714216

(51) Int. Cl. G09F 11/00; B44C 3/02; B44C 5/04; B31F 7/00

(52) U.S. Cl. 40/491; 428/38; 428/12; 493/394; 493/340

(57) ABSTRACT

A display device including a generally planar sheath member having a first panel and a second panel with a space therebetween; the sheath member including at least one window opening on the first panel and having at least one window element positioned to cover the window opening. The at least one window element having first display material thereon, and second display material arranged on a facing portion of the second panel. The display device further includes a slide member disposed in the space and movable between a first position in which the slide member is substantially wholly received within the space such that the first display material is visible and such that the slide member covers the second display material and a second position in which the first display material and the second display material are visible. A blank for forming the display device and a method for producing a display device from the blank are also disclosed.

### FIELD OF THE INVENTION

The present invention relates to the field of display devices, and more particularly, relates to a display device made of paper, cardboard, paperboard and the like, used in displaying information that appears to alter when a sliding portion is moved between first and second positions.

### BACKGROUND OF THE INVENTION

Advertising and display devices are well known in the art. Companies looking to promote particular products are always looking for innovative and new ways of displaying or otherwise presenting advertising materials. Some prior art ways of increasing the attractiveness of advertising material has included providing pop-up type devices, providing images viewable with three-dimensional glass, providing mystery advertising materials that display the completed message upon assembly or rearrangement of elements, and other materials that provide a change in character of the advertising material based on user interaction.

Display devices having moving portions that reveal additional display information are also known in the art. Such devices are used as advertising materials with enhanced capability and to present information in a unique and highly appealing matter over general planar materials with printed advertising materials thereon. One such display device is disclosed in Canadian Patent Application 2,507,747 and published Dec. 18, 2005 to Richard Burtch. This device includes a planar sheath member formed by first and second panels secured together so as to define a space therebetween, and a slide member disposed in the space movable between first and second positions. Printed material is produced on the slide member and on a surface behind the slide member such that in the first position, printed material on the slide member is visible through a window formed on the first panel of the sheath and when the slide member is moved to the second position, printed material formed on a surface of the sheath behind the slide member is viewable through the window.

The aforementioned prior art device is sufficient for displaying a first piece of information, moving the slide member and then displaying a second piece of information. However, this device does not display information or advertising materials that transitions from a first state to a second state.

Other prior art devices that involve user interaction are often complex to use or manufacture, require multiple pieces of cardboard, paper, plastics, or other materials to be assembled and have high manufacturing costs.

Accordingly, there is a need in the art for an improved display device having display information or other advertising materials that appears to transition, and solves one or more of the aforementioned prior art deficiencies.

### SUMMARY OF THE INVENTION

In accordance with a first embodiment of the present invention there is disclosed a display device having a generally planar sheath member including a first panel and a second panel with a space therebetween; the sheath member including at least one window opening on the first panel and having at least one window element positioned to cover the window opening. The at least one window element having first display material printed thereon. Second display material is arranged on a facing portion of thee second panel. A slide member is disposed in the space and movable between a first position in which the slide member is substantially wholly received within the space such that the first display material is visible and such that the slide member covers the second display material and a second position in which the first display material and the second display material are visible.

According to one aspect of the first embodiment, when the display device is in the second position, the first display material and the second display material cooperate to display a message distinct from that displayed by the first display material and the second display material individually. Furthermore, the first display may comprise an outline of an image and the second display material may comprise a colour-filled duplicate of the image such that when the slide member is in the first position, the outline of the image is visible, when the slider is in the second position, the image appears colour-filled, and when the slider is moved between the first position and second positions, the image appears to be transforming from the outline of the image to the colour-filled duplicate. Additional display material may be provided on any one of the first panel, the second panel and/or the slide member.

According to another aspect of the first embodiment, the at least one window element may be formed from an acetate window, and may be secured to an interior surface of the first panel by at least one glue spot positioned adjacent to the at least one opening.

According to another aspect of the first embodiment, a means to limit motion of the slide member is provided, the means including first and second inner side walls defining a channel in the said slide member slides and first and second stops extending into the channel from opposite sides of the side walls. The slide member includes first and second stop elements on opposite sides thereof for, upon movement of the slide member to the second position, engaging the stop elements of the sheath member to limit sliding movement of the slide member.

According to another aspect of the first embodiment, cut-out portions proximate a top end of the first and second panel are provided to form an engagement region for a user to move said slide member.

According to a second embodiment of the present invention, a blank for making a display device according to the first embodiment is provide. The blank includes a first panel having a first end edge and a second end edge opposite the first end edge the first panel further comprising a window opening therethrough; a window element, having first display material disposed thereon, on the first panel to cover the window opening. The blank further includes a second panel having a first end edge and a second end edge, the first end edge of the second panel connected to the second end edge of the first panel, thereat forming a first fold line. The second panel including second display material disposed at a position on the second panel corresponding with a position of the window opening on said first panel. The blank further includes a third panel having a first end edge and a second end edge, the first end edge of the third panel connected to the second end edge of the second panel, thereat forming a second fold line. The third panel further includes a central portion adapted to be detached from the third panel.

According to one aspect of the second embodiment, the blank further includes first and second elongate parallel cutouts formed on the third panel and extending parallel to the first and second end edges of the third panel and flanking a central area of the third panel. The cutouts preferably each have inner and outer opposite sides and further include an inner cut line forming an extension of, and extending outwardly in a first direction from, the inner side of the respective cutout and an outer cut line forming an extension of and extending outwardly in a second, opposite direction from, the outer side of the respective cutout, so as to form cooperating stops adjacent to the inner and outer cut lines when the blank is assembled. Generally, the central portion is formed on the central area.

According to a third embodiment of the present invention, there is provided a method of manufacturing a display device comprising providing an elongate foldable blank in accordance with the second embodiment previously described, printing first display material on the window element and second display material on the second panel at a position corresponding to the window element on said first panel, folding the blank at the second fold line, folding the blank at the first fold line, detaching the central portion from the third panel to thereby form a slide member, and including glue spots applied at positions along one or more of the first panel, the second panel and the third panel such that upon folding the blank, the first and second panels form a sheath member with a space therebetween and the central cutout forms a slide member disposed within the space.

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a front view of a display device, in a first position, according to a one embodiment of the present invention.

FIG. 2 is a front view of the display device of FIG. 1, in transition, according to one embodiment of the present invention.

FIG. 3 is a front view of the display device of FIG. 1, in a second position, according to one embodiment of the present invention.

FIG. 4 is a front sectional view of the display device of FIG. 1 according to one embodiment of the present invention.

FIG. 5 is a perspective view of the display device of FIG. 1 according to one embodiment of the present invention.

FIG. 6 is a top plan view of a blank for making a display device according to a second embodiment of the present invention.

### DETAILED DESCRIPTION OF THE PREFERRED EMBODIMENTS

The present invention will now be described with reference to various embodiments thereof. Such embodiments relate to a blank for forming a display device, the device as formed from the blank, and a method of manufacturing the device according to the present invention. It will be understood by those skilled in the art that while certain features will be described with respect to one embodiment only, for example with respect to the device, such features are equally applicable and may also be included on the blank for forming the display device and steps for providing such features in the method of manufacturing the device. Furthermore it will be understood by those skilled in the art that any particular blank herein described when folded and otherwise assembled into a display device, results in a display device that is within the scope and teaching of the present invention. Furthermore, display devices as herein described can be formed from blanks that within the scope and teaching of the present invention, even where specific reference to elements on a display device described is not similarly described on a blank.

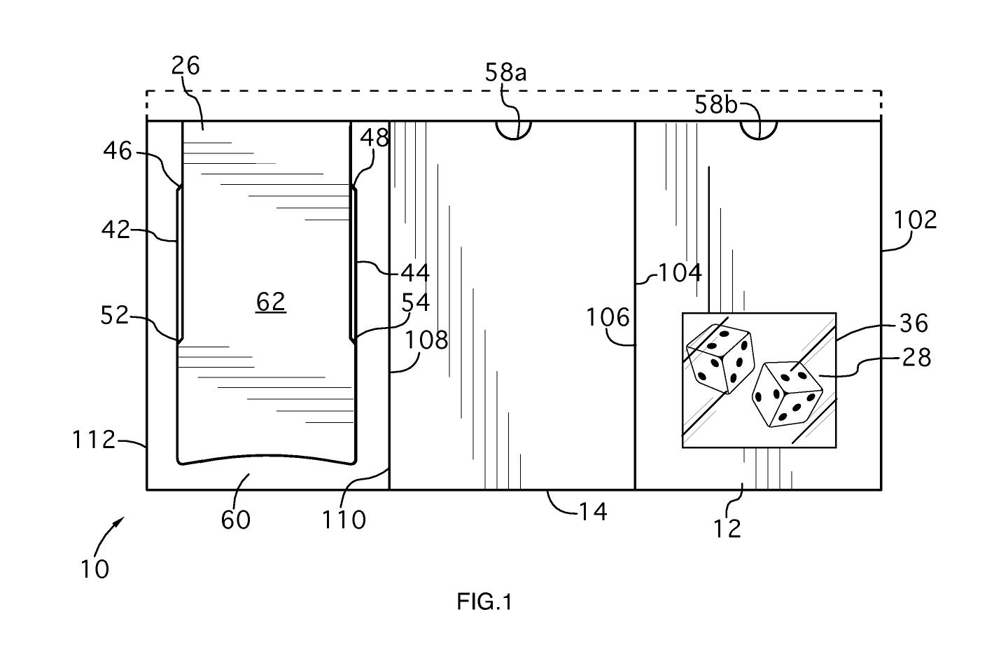

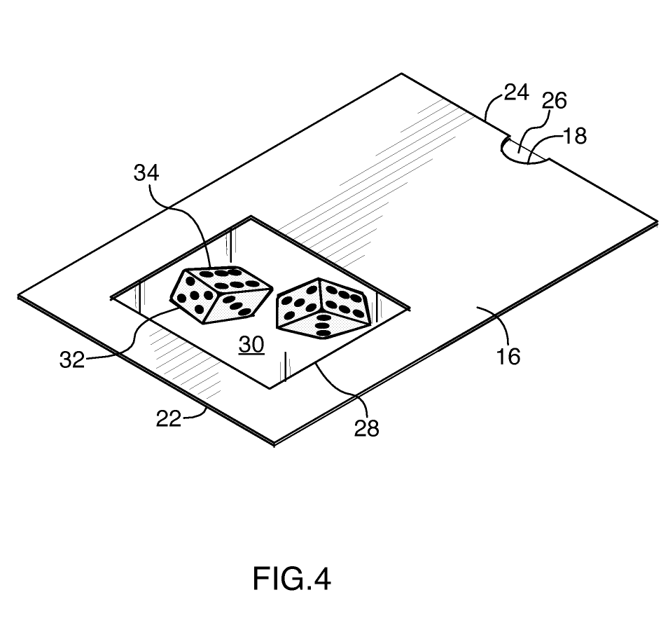

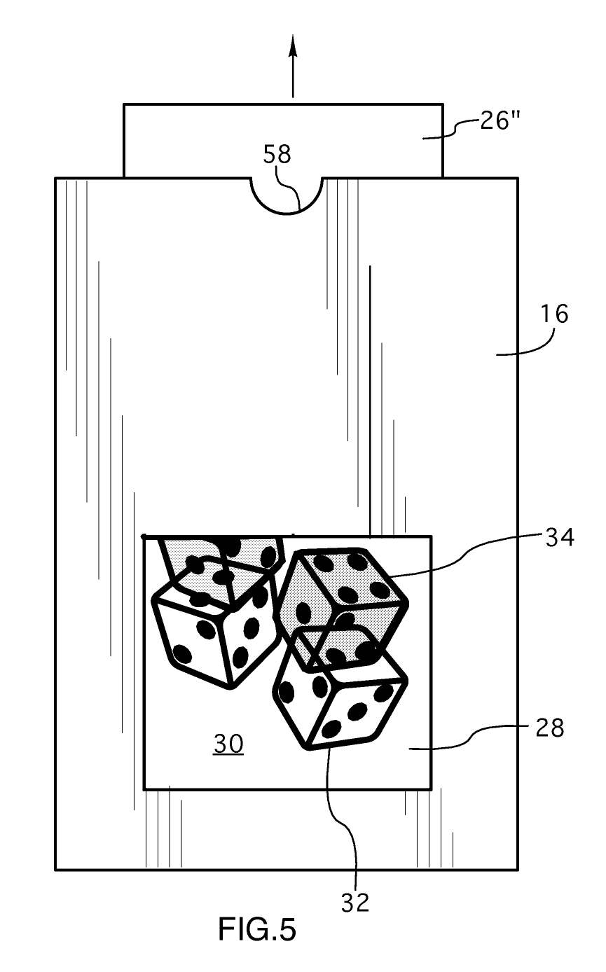

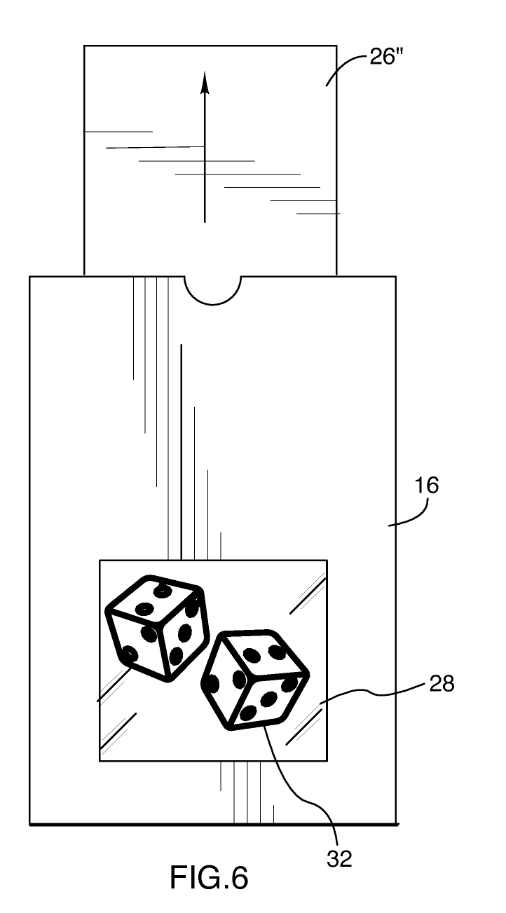

Referring now to FIGS. 1 to 6, there is shown a display device according to one embodiment of the present invention. The display device 10 generally includes a first panel 12 and a second panel 14 joined together to thereby form a generally planar sheath member 16 having a space 18 therebetween. Preferably, the space 18 is formed such that an opening 24 is provided at a top end 20 of the sheath member 16, but is otherwise closed at a bottom end 22 of the sheath member 16. The space 18 is adapted to support a slide member 26 therein such that the slide member 26 is movable between a first position of the slide member 26, as shown in FIG. 4 to a second position of the slide member 26″, as shown in FIG. 6. FIG. 5 shows the slide member 26′ in transition between the first position and the second position.

A window opening 28 is formed on the first panel 12 of the sheath member 16 such that a portion of an inner surface of the second panel 14 may be visible through the first panel 12. Optionally, additional window openings may be formed in a similar manner to provide similar results as described below. Positioned within the window opening 28 is a window element 36. Preferably, the window element 30 will be attached to an inner surface of the first panel 12 to thereby cover the entire window opening 28. The window element 30 preferably has at least first display material 32 thereon, as will be more fully described below.

Disposed on an inner surface of the second panel 14 is second display material 34. Second display material 34 is preferably positioned and arranged on a facing portion and at a location that corresponds to the location of the window opening 28, such that the second display material 34 may be viewable through the window opening 28 on the first panel 12. It will further be understood that the window opening 28 and the window element 30 may be formed in any shape, size, and orientation as would be visually appealing, or appropriate to display the desired advertising, display or informative information according to the present invention.

The window element 30 is preferably formed from a transparent, or substantially transparent material. According to a preferred embodiment, window element 30 is formed from an acetate sheet. In other embodiments, the window element 30 may be partially transparent, or selectively transparent such that only selective portions of display material 34 on the inner surface of the second panel 14 may be visible through the window element 30. Preferably, the window element 30 is sized slightly larger than the window opening and is attached to the first panel 12 by a series of glue spots on an interior surface of the first panel 12.

The slide member 26 is preferably opaque and arranged such that it is movable between a first position in which the slide member is substantially wholly received within the space 18 such that both the first display material 32 and the second display material 34 are visible, and a second position 26′ in which only the first display material 32 disposed on the window element 36 is visible. It will be understood by those skilled in the art that the arrangement of the slide member 26, window element 36, first display material 32 and second display material 34 allows for at least two distinct images, text, or advertising to be displayed. Preferably, as the slide member 26 is moved between the first position to the second position, certain visual transitional effects are displayed, as shown in FIG. 5.

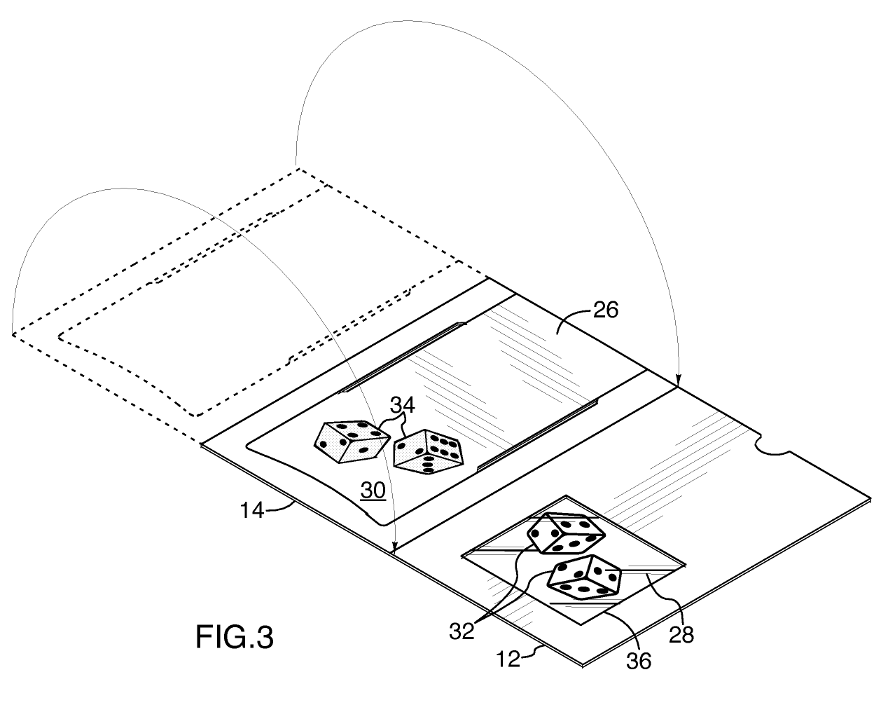

As will be understood by those skilled in the art, any combination of images and messages to be displayed are made possible by the arrangement described above. Preferably, the first display material 32 and the second display material 34 cooperate in some manner to display a message or image distinct from that displayed by the first display material 32 and the second display material 34 individually. To better illustrate this, as shown in FIG. 3, the first display material 32 and the second display material 34 include a pair of die, each showing a different number of dots on facing portions thereof. When the slide member 26 is in the first position shown in FIG. 1e, the first 32 and second 34 display material cooperate to show a pair of die formed by combining the number of dots of the individual display materials. When the slide member 26 is moved to the second position of FIG. 6, only the first display material 32 is now shown (ie. on the window element 28). In transitioning from the first position of FIG. 4 to the second position of FIG. 6, a visual effect is provided to show the changing values on the face of the die. It will be understood by those skilled in the art that other modifications and types of display material are also possible. For example, first and second display material may form parts of words that cooperate to together show a different word.

Furthermore, the first display material 32 may include an outline of an image and the second display material may include a colour-filled duplicate of the same image such that when the slide member 26 is in said first position, the outline of the image is visible, when the slide member 26 is in said second position, the image appears colour-filled, and when the slide member is moved between the first position and the second position, the image appears to be transforming from the outline of the image to the colour-filled duplicate of the image. This is illustrated by way of the shaded die shown in FIG. 4, the transparent die of FIG. 6, and the transitioning shading show in FIG. 5.

The display device according to the present invention may further include a means for limiting motion of the slide member 26, such that it is not removable from the sheath 16 during the course of normal operations; that is, in moving the slide member 26 from the first position to the second position, a means for limiting motion of the slide member 26 within the sheath 16 is provided. In the illustrated embodiment, and referring now to FIGS. 1a and 1b, the means for limiting motion includes first and second inner side walls 42, 44 defining a channel 50 in which the slide member slides and first and second stops 46, 48 extending into the channel 50 from opposite sides of the side walls 42, 44. The slide member 26 includes first and second stop elements 52, 54 on opposite sides thereof for, upon movement of the slide member 26 to the second position, engaging the stop elements 46, 48, respectively of the sheath member 16 to limit sliding movement of the slide member 26.

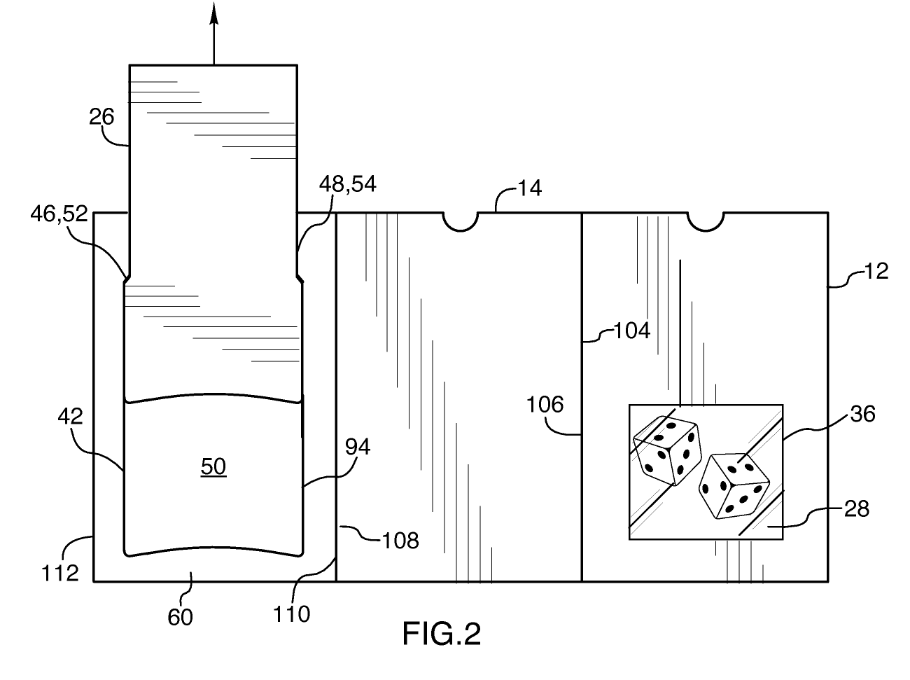

The result of the aforementioned structure, is a pocket, or channel 50, within the sheath 16 in which the slide member 26 travels in a constrained fashion. The limits of travel of the slide member 26 are preferably set such that at one end, as shown in FIG. 1, the slide member 26 is wholly received within the channel 50 and at the other end, as shown in FIG. 2, the slide member 26 is prevented from being removed from the channel 50. At this position, the slide member 26 is preferably supported within the sheath such that it does not flex or bend to such an extent that the sliding movement within the channel 50 is hampered by any permanent deformation in the slide member 26.

Preferably, in order to facilitate handling of the slide member 26 and interaction with a user, cut out portions 58a and 58b are formed proximate a top end of 24 of the first and second panels 12, 14. The cumulative cut-out portion 58 provides an engagement region proximate a top end of the slide member 26 to be grabbed by the user to move the slide member 26 between the first and second positions.

According to a second embodiment of the present invention, the display device 10 is preferably formed from a singular blank of card stock, or similar material. FIG. 1a generally shows the blank and includes the first panel 12 having a first end edge 102 and a second end edge 104 opposite the first end edge 102. The first panel 12 further includes window opening 28, preferably proximate a lower quarter region of the first panel 12. The window element 36, preferably formed from acetate, is disposed on the first panel 12 to cover the window opening and includes the first display material 32 (not shown in FIG. 1, but described in detail above) printed thereon.

A second panel 14 is also provided, adjacent to the first panel 12, and including a respective first end edge 106 and a second end edge 102, with the first end edge 106 of the second panel 14 connected to the second end edge 102 of the first panel 12. The intersection of the edges 102 and 106 form a first fold line. The second panel 14 further includes second display material (not shown in FIG. 1, but described in detail above) disposed at a position on the second panel 14 corresponding with a position of the window opening 28 on the first panel 12.

In addition, a third panel 60, is provided including a first end edge 108 and a second end edge 112. The first end edge 108 of the third panel is connected to the second end edge 110 of the second panel 14. The intersection of the edges 108 and 110 forms a second fold line. The third panel 60 further includes a central portion 62 adapted to be detached from the third panel, and in use, forms the slide member 26 earlier described.

The aforementioned blank, when fully assembled, forms the display device 10 of the first embodiment of the present invention described above. In order to provide the means for limiting motion, the blank preferably includes first and second elongate parallel cutouts formed on the third panel 60 and extending generally parallel to the first and second end edges 110, 112 of the third panel and flanking a central area of the third panel 60 as shown in FIG. 1. The cutouts are generally bounded by the sidewalls, 42, 44 and each include inner and outer opposite sides formed from an inner cut line forming an extension an extension of, and extending outwardly in a first direction from the inner side of the respective cutout and an outer cut line forming an extension of and extending outwardly in a second, opposite direction from, the outer side of the respective cutout. This arrangement results in the formation of cooperating stops 46, 48 adjacent to the inner and outer cut lines when the blank is assembled.

With reference to the aforementioned blank, a method of manufacturing the display device 10 from the blank includes the steps of providing an elongate, foldable blank having a first panel 12 with a first end edge 102 and a second end edge 104 opposite the first end edge. The first panel 12 further including a window opening 28 therethrough with a window element 36 disposed on the first panel 12 to cover the window opening. The blank further includes a second panel 14 having a first end edge 106 and a second end edge 108, arranged such that the first end edge 106 of said second panel 14 is connected to the second end edge 104 of said first panel 12, thereat forming a first fold line. A third panel 60 is provided having a first end edge 110 and a second end edge 112, and arranged such that the first end edge 110 of the third panel 60 is connected to the second end edge 108 of the second panel 14, thereat forming a second fold line. The third panel 60 further includes a central portion 62 adapted to be detached from the third panel 60.

With reference now to FIGS. 1 to 3, the method further includes the steps of printing first display material 32 on the window element 36 and second display material 34 on the second panel 14 at a position corresponding to the window element 36 on the first panel 12, folding the blank at the second fold line 108/110, folding the blank at the first fold line 104/106, detaching the central portion 62 from the third panel 60 to thereby form a slide member 26. Glue spots may then be applied at various positions along one or more of the first panel 12, the second panel 14 and the third panel 60 such that upon folding the blank (as shown in FIG. 3), the first and said second panels 12, 14 form the sheath member 16 with a space 28 therebetween and the central cutout 62 forms the slide member 26 disposed within the space 28, as previously described with respect to the first embodiment of the present invention.

The method preferably further includes, prior to folding along the first and second fold lines, forming first and second elongate cutouts on the third panel; the first and second elongate cutouts extending parallel to the first and second end edges 108, 112 of the third panel 60 and flanking a central area 62 of the third panel 60. Then, forming an inner cut at an extension of, and extending outwardly in a first direction from, the inner side of the respective cutout and forming an outer cut at an extension of, and extending outwardly in a second, opposite direction from, the outer side of the respective cutout, thereby forming cooperating stops adjacent to the inner and outer cut lines when the blank is assembled.

Optionally, the aforementioned steps associated with forming the cooperating stops may be performed prior to the printing step.

Other modifications and alterations may be used in the design and manufacture of other embodiments according to the present invention without departing from the spirit and scope of the invention, which is limited only by the accompanying claims. For example, the device as described above may be used wherever it is convenient or advantages to display material in the form herein described, including, but not limited to displays for advertising, information, teaching, scheduling, entertainment, greeting cards, and any other display use as would be apparent to those skilled in the art.

Furthermore, it will be understood by those skilled in the art that while the aforementioned display device has been described with respect to card stock, other foldable materials may also be used, whether such folding is manual, machine based, or requires custom machinery adapted to fold the material. The present invention is not limited to the use of card stock for forming the display device.

What is claimed is:

1. A display device comprising:
i. a generally planar sheath member including a first panel and a second panel having a space therebetween;
ii. said sheath member including at least one window opening on said first panel and having at least one window element positioned therein, said at least one window element having first display material thereon;
iii. second display material arranged on a facing portion of said second panel;
iv. a slide member disposed in said space and movable between a first position in which said slide member is substantially wholly received within said space such that said first display material is visible and such that said slide member covers said second display material and a second position in which said first display material and said second display material are visible.

2. A display device according to claim 1, wherein in said second position, said first display material and said second display material cooperate to display a message distinct from that displayed by said first display material and said second display material individually.

3. A display device according to claim 2, wherein said first display comprises an outline of an image and said second display material comprises a colour-filled duplicate of said image such that when said slide member is in said first position, said outline of said image is visible, when said slider is in said second position, said image appears colour-filled, and when said slider is moved between said first position and said second position, said image appears to be transforming from said outline of said image to said colour-filled duplicate of said image.

4. A display device according to claim 1, wherein said at least one window element comprises an acetate window.

5. A display device according to claim 1, further comprising at least one glue spot on an interior surface of said first panel, adjacent said at least one opening and adapted to secure said acetate window element to said first panel.

6. A display device according to claim 1, further comprising first and second inner side walls defining a channel in which said slide member slides and first and second stops extending into said channel from opposite sides of said side walls, and said slide member including first and second stop elements on opposite sides thereof for, upon movement of said slide member to said second position, engaging said stop elements of said sheath member to limit sliding movement of the slide member.

7. A display device according to claim 6, further comprising additional display material on any one of said first panel, said second panel and said slide member.

8. A display device according to claim 7, further comprising cut-out portions proximate a top end of said first and second panel, said cut-out portions providing an engagement region for a user to move said slide member.

9. A blank for making a display device comprising:
i. a first panel having a first end edge and a second end edge opposite the first end edge; said first panel further comprising a window opening therethrough;
ii. a window element disposed on said first panel to cover said window opening; said window element having first display material disposed thereon;
iii. a second panel having a first end edge and a second end edge, said first end edge of said second panel connected to said second end edge of said first panel, thereat forming a first fold line; said second panel having second display material disposed at a position on said second panel corresponding with a position of said window opening on said first panel;
iv. a third panel having a first end edge and a second end edge, said first end edge of said third panel connected to said second end edge of said second panel, thereat forming a second fold line; said third panel further including a central portion adapted to be detached from said third panel;
wherein, in use of a device assembled from the blank, said first and said second panels form a sheath member with a space therebetween and said central portion forms a slide member disposed within said space upon detachment from third panel.

10. A blank for making a display device according to claim 9, further comprising first and second elongate parallel cutouts formed on said third panel and extending parallel to the first and second end edges of the third panel and flanking a central area of said third panel, said cutouts each having inner and outer opposite sides and each of the first and second cutouts further including an inner cut line forming an extension of, and extending outwardly in a first direction from, the inner side of the respective cutout and an outer cut line forming an extension of and extending outwardly in a second, opposite direction from, the outer side of the respective cutout, so as to form cooperating stops adjacent to said inner and outer cut lines when the blank is assembled; and wherein said central portion is formed on said central area.

11. A blank for making a display device according to claim 10, wherein said window element comprises an acetate window joined to said first element.

12. A method of manufacturing a display device, comprising:
providing an elongate, foldable blank comprising:
a first panel having a first end edge and a second end edge opposite said first end edge; said first panel further comprising a window opening therethrough;
a window element disposed on said first panel to cover said window opening;
a second panel having a first end edge and a second end edge, said first end edge of said second panel connected to said second end edge of said first panel, thereat forming a first fold line;
a third panel having a first end edge and a second end edge, said first end edge of said third panel connected to said second end edge of said second panel, thereat forming a second fold line;
said third panel further including a central portion adapted to be detached from said third panel;
printing first display material on said window element and second display material on said second panel at a position corresponding to said window element on said first panel;
folding said blank at said second fold line;
folding said blank at said first fold line;
detaching said central portion from said third panel to thereby form a slide member;
wherein glue spots are applied at positions along one or more of said first panel, said second panel and said third panel such that upon folding said blank, said first and said second panels form a sheath member with a space therebetween and said central cutout forms a slide member disposed within said space.

13. A method of manufacturing a display device according to claim 12, further comprising, prior to said folding steps,
forming first and second elongate cutouts on said third panel; said first and second elongate cutouts extending parallel to the first and second end edges of the third panel and flanking a central area of said third panel, said cutouts each having inner and outer opposite sides,
forming an inner cut at an extension of, and extending outwardly in a first direction from, the inner side of the respective cutout
forming an outer cut at an extension of, and extending outwardly in a second, opposite direction from, the outer side of the respective cutout,
thereby forming cooperating stops adjacent to said inner and outer cut lines when the blank is assembled; and wherein said central portion is formed on said central area.

14. A method of manufacturing a display device according to claim 12, further comprising, prior to said printing step,
forming first and second elongate cutouts on said third panel; said first and second elongate cutouts extending parallel to the first and second end edges of the third panel and flanking a central area of said third panel, said cutouts each having inner and outer opposite sides,
forming an inner cut at an extension of, and extending outwardly in a first direction from, the inner side of the respective cutout
forming an outer cut at an extension of, and extending outwardly in a second, opposite direction from, the outer side of the respective cutout,
thereby forming cooperating stops adjacent to said inner and outer cut lines when the blank is assembled; and wherein said central portion is formed on said central area.
